(19) United States
(12) Patent Application Publication
(10) Pub. No.: US 2013/0269647 A1
(43) Pub. Date: Oct. 17, 2013

(54) VALVE SEAT INSERT

(71) Applicants: Ajay Kumar Pandey, Rochester, MI (US); Devin R. Hess, Burton, MI (US); Mark A. Osborne, Grand Blanc, MI (US)

(72) Inventors: Ajay Kumar Pandey, Rochester, MI (US); Devin R. Hess, Burton, MI (US); Mark A. Osborne, Grand Blanc, MI (US)

(73) Assignee: GM GLOBAL TECHNOLOGY OPERATIONS LLC, Detroit, MI (US)

(21) Appl. No.: 13/446,080

(22) Filed: Apr. 13, 2012

(51) Int. Cl. F01L 3/22; F02F 1/42; F16K 1/42

(52) U.S. Cl. 123/193.5; 251/359; 123/188.8

(57) ABSTRACT

A valve seat insert including an annular body disposed about a central axis. The annular body includes a radially inward face that defines an orifice and a radially outward face that is opposite the radially inward face. Additionally, the annular body includes a top face, and a bottom face that is opposite the top face. The valve seat insert further includes a plurality of heat transfer protrusions that extend from the radially outward face of the annular body.

### TECHNICAL FIELD

The present invention relates to a valve seat insert that is configured to be installed within the cylinder head of an engine.

### BACKGROUND

A valve seat in an internal combustion gasoline or diesel engine is the surface of the cylinder head against which an intake or an exhaust valve rests during the portion of the engine operating cycle when that valve is closed. Maintaining proper tolerances between the valve seat and valve is important over the life of the engine, in that if the valve seat becomes deformed, or is improperly positioned, oriented, or formed during manufacture, leakage of gaseous fluids will occur which will adversely affect the engine compression ratio and therefore the engine efficiency, performance (horsepower), exhaust emissions, and engine life.

### SUMMARY

A valve seat insert may include an annular body disposed about a central axis. The annular body may have a radially inward face that defines an orifice and a radially outward face that is opposite the radially inward face. Additionally, the annular body may have a top face, and a bottom face that is opposite the top face. The valve seat insert further includes a plurality of heat transfer protrusions that extend from the radially outward face of the annular body.

In one configuration, at least one of the plurality of heat transfer protrusions may be a wedge-shaped protrusion that is substantially aligned with the central axis. The wedge-shaped protrusion may include a first end and a second end, wherein the first end of the wedge-shaped protrusion may extend a greater distance away from the radially outward face than the second end of the wedge-shaped protrusion. The first end of the wedge-shaped protrusion may also be substantially aligned with the top face of the annular body.

The insert may be configured to be press-fit into the cylinder head of an engine, such that the plurality of heat transfer protrusions plastically deforms the cylinder head of the engine. Likewise, a cylinder head for an engine may include a cylinder head body that defines a plurality of valve openings, with each valve opening including a respective recess configured to receive a valve seat insert. The cylinder head may further include a valve seat insert, of the kind described above, disposed within each of the plurality of recesses.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective view of a cylinder head of an engine.

FIG. 2 is a schematic perspective view of a valve seat insert.

FIG. 3 is an enlarged schematic perspective view of a portion of a valve seat insert.

FIG. 4 is a schematic cross-sectional view of a valve seat insert disposed in a cylinder head body.

### DETAILED DESCRIPTION

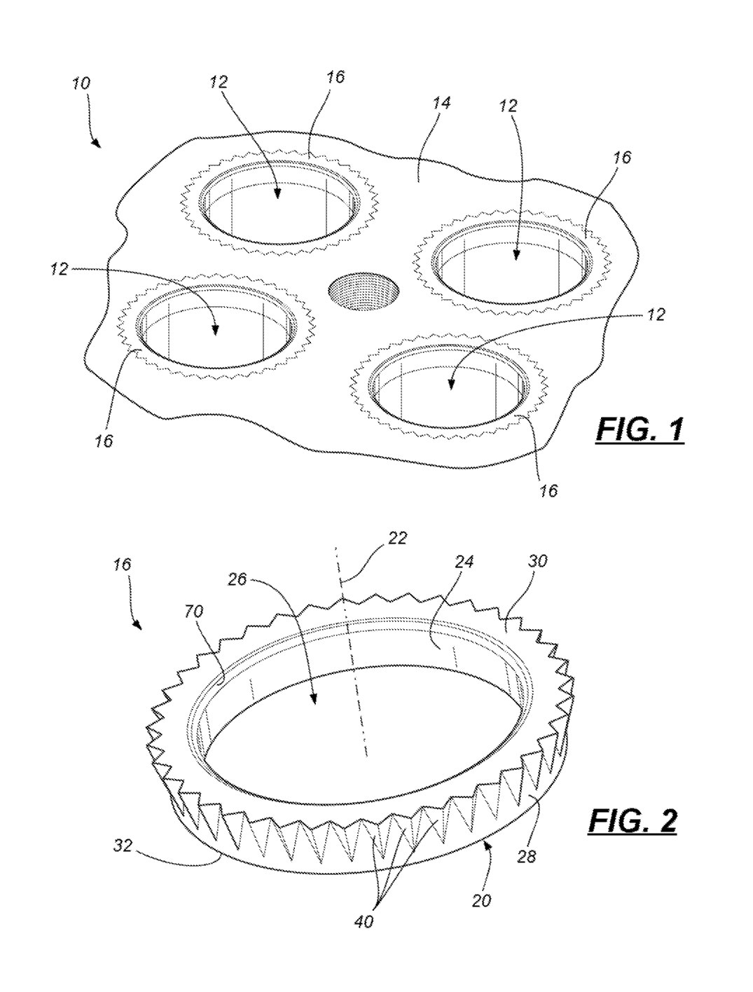

Referring to the drawings, wherein like reference numerals are used to identify like or identical components in the various views, FIG. 1 schematically illustrates a cylinder head 10 of an engine. As shown, the cylinder head 10 includes a plurality of valve openings 12 that may be configured as either intake openings or exhaust openings. As understood in the art, an intake opening may allow fresh air or an air/fuel mixture to enter a combustion chamber/cylinder of the engine. Following combustion of the air/fuel mixture, the by-products of the combustion may flow out of the cylinder via the exhaust openings. During the compression and power strokes of the engine, the valve openings 12 may be sealed by valve heads (not shown), which may be seated within the respective openings 12.

The cylinder head 10 may include a cylinder head body 14 that may define the structure of the cylinder head 10, including the respective valve openings 12. The cylinder head body 14 may be formed from a metal, such as cast aluminum, as is typical in the art. In addition to defining the respective valve openings 12, the cylinder head body 14 may further define an annular recess about each respective valve opening 12 that is configured to receive a valve seat insert 16. The valve seat insert 16 may be a precision-formed inlay that may selectively receive the valve head to seal the valve opening 12. The valve seat insert 16 may comprise a material that is harder than the cylinder head body 14, and may exhibit greater wear-resistant properties than the material of the cylinder head body 14. For example, the valve seat insert may be a metallic alloy comprising cobalt, nickel, iron, aluminum, boron, carbon, chromium, manganese, molybdenum, phosphorus, sulfur, silicon, and/or titanium.

As generally illustrated in FIG. 2, the valve seat insert 16 may include an annular body 20 that is disposed about a central axis 22. The valve seat insert 16 may include a radially inward face 24 that generally defines an orifice 26, and may include a radially outward face 28 that is opposite the radially inward face 24. The valve seat 16 may further include both a top face 30 and a bottom face 32 that is opposite the top face 30.

Referring again to FIG. 1, the valve seat insert 16 may be press-fit into the recess defined by the cylinder head body 14 such that the radially outward face 28 contacts the cylinder head body 14 and the orifice 26 is generally aligned with the valve opening 12 of the cylinder head 10.

As illustrated in FIG. 2, the valve seat insert 16 may include a plurality of heat transfer protrusions 40 that each extend out from the radially outward face 28 of the annular body 20. As shown in FIG. 2, each of the respective heat transfer protrusions 40 may be, for example, a wedge-shaped protrusion. Alternate designs may include protruding fins, blades, hemispheres, or other similar designs configured to increase the surface area contact between the insert 16 and the cylinder head body 14. It should be noted that FIG. 2 has been drawn to exaggerate the scale of the respective heat transfer protrusions 40. In practice, the degree to which they extend from the radially outward face 28 of the annular body 20 may be different than shown (e.g., smaller or larger). Additionally, the number of protrusions 40 around the outer circumference may be fewer or greater than shown in FIG. 2.

Each heat transfer protrusion 40 may be configured to increase the surface area contact between the valve seat insert 16 and the cylinder head body 14 beyond that of a simple annular ring. The increased surface area may correspondingly increase the ability for heat to pass between the insert 16 and cylinder head body 14 (i.e., across the insert-body junction) in view of the press-fit interface. In many automotive applications, the cylinder head body 14 may be actively cooled, such as through water-cooling methods. By maximizing the ability to conduct heat out of the valve seat insert 16 and into the cooler cylinder head body 14, the wear-resistant properties of the insert 16 may be maximized, while any thermal deformation of the insert 16 may be minimized. In this manner, the life and performance of the valve seat insert, and the sealing properties of the overall cylinder head valve may be increased.

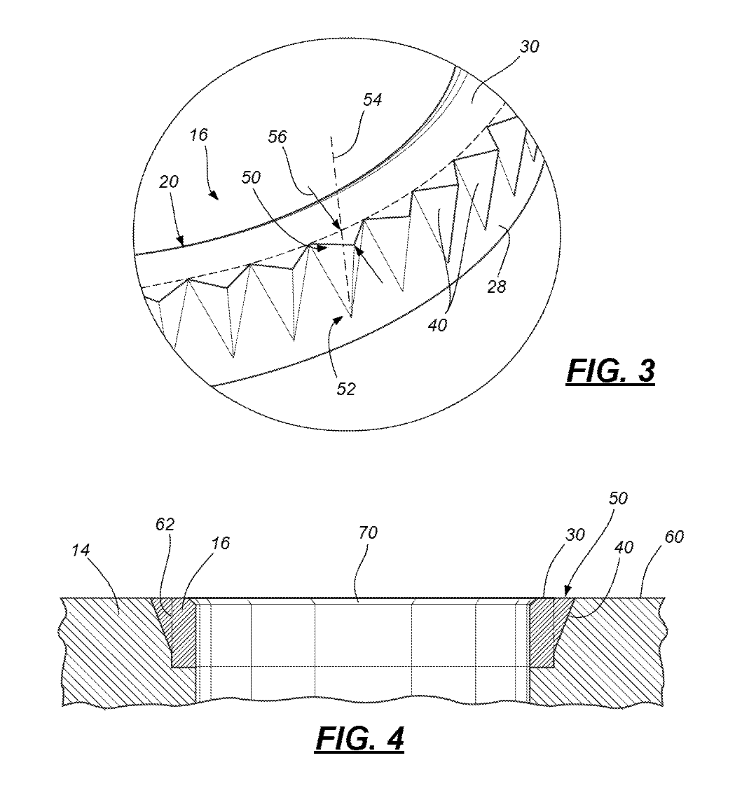

As further illustrated in FIG. 2, each of the plurality of protrusions 40 may be substantially aligned with the central axis 22 such that while the valve seat insert 16 is press-fit into the cylinder head body 14, the protrusions penetrate progressively deeper into the cylinder head body 14 without leaving any appreciable voids. For example, as shown in the enlarged view of FIG. 3, each wedge-shaped protrusion 40 may include a first end 50 and a second end 52 that generally define an orientation axis 54. The orientation axis 54 may be substantially parallel to the central axis 22. As shown, the first end 50 may extend from the radially outward face 28 by a distance 56. This distance 56 may be greater than the distance that the second end 52 of the protrusion 40 extends from the radially outward face 28 (which may be negligible, as shown).

As further shown in FIGS. 3 and 4, the first end 50 of the protrusion 40 may be substantially aligned with the top face 30 of the annular body 20. In this manner, as shown in FIG. 4, when inserted into the cylinder head body, both the first end of the protrusion 40 and the top face 30 of the annular body 20 may be flush with the surface 60 of the cylinder head body 14.

FIG. 4 further illustrates the recess 62 defined by the cylinder head body 14, and illustrates that the plurality of heat transfer protrusions 40 are configured to elastically and/or plastically deform the cylinder head body 14 upon insertion. Such deformation is enabled by the difference in hardness between the material of the valve seat insert 16 and the material of the cylinder head body 14. Through a sufficient application of force, the valve seat insert 16 may be inserted into the recess, while the plurality of protrusions score/cut into the cylinder head body 14. In this manner, it may be guaranteed that each protrusion is in firm contact with the cylinder head body 14. This may be advantageous over purely annular insert designs that may contact the cylinder head body 14 in as few as two or three locations.

The valve seat insert 16 may further include a valve mating face 70 that may be disposed between the radially inward face 24 and the top face 30 of the annular body 20. The valve mating face 70 may be configured to receive a valve head in a manner that may seal the orifice 26. The valve mating face 70 may include one or more chamfers, such as generally illustrated in FIG. 4, and/or may include a radius. The mating valve head may include a similar profile that is configured to nest against the valve mating face 70 and establish either line or area contact across the entire circumference of the valve seat insert 16.

While the best modes for carrying out the invention have been described in detail, those familiar with the art to which this invention relates will recognize various alternative designs and embodiments for practicing the invention within the scope of the appended claims. It is intended that all matter contained in the above description or shown in the accompanying drawings shall be interpreted as illustrative only and not as limiting.

1. A valve seat insert comprising:
an annular body disposed about a central axis, the annular body including a radially inward face defining an orifice and a radially outward face that is opposite the radially inward face, the annular body further including a top face and a bottom face that is opposite the top face; and
a plurality of heat transfer protrusions extending from the radially outward face of the annular body.

2. The insert of claim 1, wherein at least one of the plurality of heat transfer protrusions is a wedge-shaped protrusion that is substantially aligned with the central axis.

3. The insert of claim 2, wherein the wedge-shaped protrusion includes a first end and a second end;
wherein the first end of the wedge-shaped protrusion extends a greater distance away from the radially outward face than the second end of the wedge-shaped protrusion.

4. The insert of claim 3, wherein the first end of the wedge-shaped protrusion is substantially aligned with the top face of the annular body.

5. The insert of claim 1, wherein the insert is configured to be pressed into the cylinder head of an engine, and wherein the plurality of heat transfer protrusions are configured to plastically deform the cylinder head of the engine.

6. The insert of claim 1, further comprising a valve mating face disposed between the radially inward face and the top face of the annular body; and
wherein the valve mating face is configured to receive a valve head to seal the orifice.

7. A cylinder head for an engine, the cylinder head comprising:
a cylinder head body defining a plurality of valve openings, each valve opening including a respective recess configured to receive a valve seat insert;
a valve seat insert disposed within each of the plurality of recesses, each valve seat insert respectively including:
an annular body disposed about a central axis, the annular body including a radially inward face defining an orifice substantially aligned with the valve opening and a radially outward face that is opposite the radially inward face, the annular body further including a top face and a bottom face that is opposite the top face; and
a plurality of heat transfer protrusions extending from the radially outward face of the annular body.

8. The cylinder head of claim 7, wherein at least one of the plurality of heat transfer protrusions is a wedge-shaped protrusion that is substantially aligned with the central axis of the insert.

9. The cylinder head of claim 8, wherein the wedge-shaped protrusion includes a first end and a second end;
wherein the first end of the wedge-shaped protrusion extends a greater distance away from the radially outward face than the second end of the wedge-shaped protrusion.

10. The cylinder head of claim 9, wherein the first end of the wedge-shaped protrusion is substantially aligned with the top face of the annular body of the respective valve insert.

11. The cylinder head of claim 7, wherein the valve insert is configured to be press-fit into the recess defined by the cylinder head body, and wherein the plurality of heat transfer protrusions are configured to plastically deform the cylinder head body.

12. The cylinder head of claim 7, wherein each of the respective valve seat inserts further include a valve mating face disposed between the radially inward face and the top face of the respective annular bodies; and
wherein each valve mating face is configured to receive a valve head to seal the respective valve opening.

13. The cylinder head of claim 7, wherein each of the respective valve seat inserts comprise a metal with a greater hardness than the hardness of the cylinder head body.
